(19) United States
(12) Patent Application Publication
(10) Pub. No.: US 2020/0065746 A1
(43) Pub. Date: Feb. 27, 2020

(54) ORDER MANAGEMENT SYSTEM FOR E-RETAIL ORDERS

(71) Applicant: Target Brands, Inc., Minneapolis, MN (US)

(72) Inventors: SRIKANTH GARNEPUDI, Minneapolis, MN (US); MOHIT SINGAL, Bangalore (IN); RAHUL CHOKHANI, Bangalore (IN); KUMARAN MALLI NATARAJAN, Minneapolis, MN (US); NICHOLAS KAISER, Minneapolis, MN (US); KRISTEN WASSON, Minneapolis, MN (US)

(21) Appl. No.: 16/109,019

(22) Filed: Aug. 22, 2018

(51) Int. Cl. G06Q 10/08; G06Q 30/06

(52) U.S. Cl. CPC G06Q 10/087; G06Q 10/083; G06Q 30/0639

(57) ABSTRACT

A method comprises receiving an e-retail order comprising one or more products sold through an e-retail application associated with an established infrastructure of a plurality of retail sites and a plurality of flow centers and determining a location of a primary retail site closest proximity to a delivery address associated with the e-retail order. The method further comprises determining a location of the ordered products within the infrastructure and the most cost-effective handling option to place the ordered products at the primary retail site. The most cost-effective handling option is based on initiating delivery of a shippable unit containing the ordered products from the primary retail site. The method further comprises executing the most cost-effective handling option and initiating delivery of the shippable unit to the delivery address from the primary retail site.

### TECHNICAL FIELD

The present disclosure is directed to order management systems, and, more particularly to an order management systems for e-retail orders.

### BACKGROUND

In the context of e-retailers, e.g. retailers that sell their products via the Internet, a typical model of operation provides for a warehouse that maintains an inventory of the hundreds of thousands of products from which a customer may select and for an order management system that directs the fulfillment of a customer's order. For example, upon receiving an e-retail/digital order, the order management system directs the picking of the ordered products from the warehouse inventory and further directs the warehouse packaging of the ordered products into one or more shippable units. The shippable units are typically collected from the warehouse by a delivery service, such as the US Postal Service, United Parcel Service or FedEx, for shipping and delivery to the customer.

The cost associated with the shipping and delivery can vary significantly dependent upon the proximity of the warehouse to the delivery address of the customer as it may be necessary for the shippable units to travel through multiple points of transfer within the delivery service route before the actual delivery of the shippable units to the customer. The cost associated with the shipping and delivery can be passed directly to the ordering customer or can be spread among a multitude of digital orders such that all shipments can be shipped at a similar rate. The strategic placement of additional warehouses, e.g., reducing the distance between warehouse and customer address, can help to reduce actual shipping costs but presents the problem of new costs associated with building, maintaining, and re-stocking of the warehouse.

### SUMMARY

The present disclosure is directed to an order management system that utilizes existing infrastructure such as established retail sites, established flow centers associated with the retail sites, and established hauling routes between retail sites and flow centers to additionally provide the service of e-retailing. More specifically, the order management system provides the ability to receive and reactively respond to e-retail orders for physical products placed via the Internet. Upon receiving an e-retail order, the order management system of the present disclosure is able to perform a reactive cost analysis to determine the most cost effective handling option for the picking, packaging, shipping and delivery of the customer-selected products in the e-retail order. In certain embodiments, the most cost effective option is selectable from options including: “local injection,” “store pack with local injection,” “ship injection” and “merge in transit”. Upon selection of the most cost effective handling option, the order management system generates a product transfer order that initiates and directs the acts, processes and/or operations to satisfy the selected handling option while maximizing order fulfillment through local injection.

One aspect of the present disclosure is directed to a method. The method includes the act of receiving an e-retail order comprising one or more products sold through an e-retail application that is associated with an established infrastructure of a plurality of retail sites and a plurality of flow centers. The method additionally includes the act of determining a location of a primary retail site from among the plurality of retail sites. The primary retail site comprises the retail site in closest proximity to a delivery address associated with the e-retail order.

The method also includes the acts of determining a location of the ordered products from among the inventory of the primary retail site and the inventory of a flow center associated with the primary retail site as well as determining the most cost-effective handling option to obtain the ordered products from the inventories of the primary retail site and/or the associated flow center. The determination of the most cost-effective handling option is based on initiating delivery of a shippable unit containing the ordered products from the primary retail site.

The method also includes the act of executing the determined most-cost effective handling option. The result of the execution is the shippable unit being located at the primary retail site. And, the method includes the act of initiating delivery of the shippable unit to the delivery address from the primary retail site.

Another aspect of the present disclosure is directed to a system that comprises a memory device storing instructions and a processor configured to read and execute the instructions stored in the memory device. Execution of the instructions causes the processor to receive an e-retail order comprising one or more products sold through an e-retail application that is associated with an established infrastructure of retail sites and flow centers. Execution of the instructions also cause the processor to determine a location of a primary retail site from among the plurality of retail sites. The primary retail site comprises the retail site in closest proximity to a delivery address associated with the e-retail order.

Execution of the instructions further causes the processor to determine a location of the ordered products from among the inventory of the primary retail site and the inventory of a flow center associated with the primary retail site and to determine the most cost-effective handling option to obtain the ordered products from the inventories. The determination of the most cost-effective handling option is based on initiating delivery of a shippable unit containing the ordered products from the primary retail site.

Execution of the instructions further causes the processor to issue a product transfer order to the primary retail site and/or the associated flow center having the ordered products in inventory. The product transfer order dictates whether packaging of the ordered products into the shippable unit occurs at the associated flow center or the primary retail site.

In certain embodiments, the methods and systems described above also take into consideration the use of non-primary retail sites as sources for product inventory that can be hauled to (or packaged into a shippable unit and hauled to) the primary retail site. In certain embodiments, the product inventory of the primary retail site, the flow centers, the non-primary retail sites and other fulfillment nodes within the existing infrastructure are sources for product inventory and locations from which to haul ordered products to the primary retail site.

The above summary is not intended to describe each embodiment or every implementation. A more complete understanding will become apparent and appreciated by referring to the following detailed description and claims in conjunction with the accompanying drawings.

### BRIEF DESCRIPTION OF THE DRAWINGS

FIG. 1 is a schematic depicting an architecture for implementing a digital order management system according to the present disclosure.

FIG. 2 is a simplified flowchart illustrating the basic operation of the digital order management system.

FIG. 3 is a flowchart illustrating the process, as directed by the digital order management system, for a “local injection” order handling option.

FIG. 4 is a flowchart illustrating the process, as directed by the digital order management system, for a “store pack with local injection” order handling option.

FIG. 5 is a flowchart illustrating the process, as directed by the digital order management system, for a “ship injection” order handling option.

FIG. 6 is a flowchart illustrating the process, as directed by the digital order management system, for a “merge in transit from upstream” order handling option.

FIG. 7 is a flowchart illustrating the process, as directed by the digital order management system, for a “merge in transit from local” order handling option.

FIG. 8 is a schematic depicting examples of factors that can be considered in performing a cost analysis according to the present disclosure.

FIG. 9 is a schematic of an example of a computing device that can be used in implementing the digital order management system

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Various embodiments will be described in detail with reference to the drawings, wherein like reference numerals represent like parts and assemblies through the several views. Reference to various embodiments does not limit the scope of the claims attached hereto. Additionally, any examples set forth in this specification are not intended to be limiting and merely set forth the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

An order management system of the present disclosure utilizes an architecture of established retail sites, established flow centers associated with the retail sites, and established hauling routes between retail sites and flow centers to respond to an e-retail order, a.k.a., a digital order; digital orders comprise orders for physical products that are placed via the Internet. The order management system of the present disclosure responds to a newly placed digital order by performing a reactive cost analysis to generate a product transfer order. The product transfer order puts into motion the acts, processes and/or operations, by individuals or machines, necessary to fulfill a digital order.

The product transfer order reflects the most cost effective handling option for the picking/sorting, packing, shipping and delivery of the digitally ordered products as determined by the reactive cost analysis. In certain embodiments, the most cost effective handling option is selectable from options that include: “local injection,” “store pack with local injection,” “ship injection,” “merge in transit from upstream” and “merge in transit local”. In certain examples, each of the handling options is considered with the goal of maximizing the volume for local injection of fulfilled orders from a primary retail site, or a dedicated pack and ship center, that is closest to a delivery address associated with the digital order.

### I. Architecture

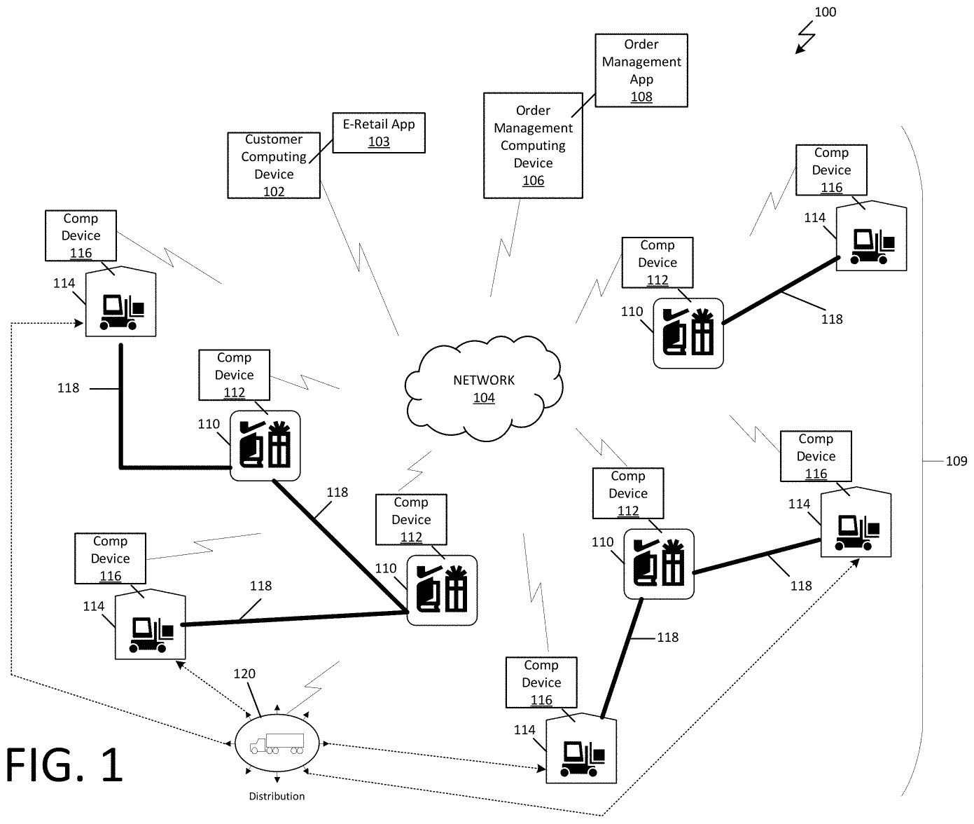

FIG. 1 illustrates an architecture 100 for implementing the order management system of the present disclosure. As shown, the architecture includes a customer computing device 102 having access to an e-retail application 103 from which products can be digitally ordered and an e-retail order generated. The customer computing device 102 is connected via a communications network 104 to an order management computing device 106, e.g., a server that executes an order management application 108. The order management application 108 includes digital instructions that enable it to: receive the e-retail order through the communications network 104, execute a reactive cost analysis of the e-retail order, generate a product transfer order to direct the picking/sorting, packaging, shipping and delivery of the e-retail order, and transmit the product transfer order to order fulfillment nodes 109. The digital instructions of the order management application 108 can include additional instructions for performing numerous other types of functions, operations and/or processes useful to responding to digital orders. For example, the order management application can include digital instructions for updating a customer with an order status, updating an inventory count, ordering products from suppliers, etc.

The fulfillment nodes 109 of the architecture 100 include a plurality of retail sites 110 each having a computing device 112 for receiving the product transfer orders and/or for otherwise communicating with the order management application 108 of the order management computing device 106. Each retail site 110 generally comprises a physical retail store that is open to the public and offers a limited number of products for sale; the limited number of products comprising a number of products that is less than the number of products that is offered via the e-retail application 103.

The fulfillment nodes 109 of the architecture 100 also include a plurality of flow centers 114 each having a computing device 116 for receiving the product transfer orders and/or for otherwise communicating with the order management application 108 of the order management computing device 106. Each flow center 114 generally comprises a physical warehouse site that houses a number of saleable products some of which are sold only through the retail sites 110, some of which are sold through both the retail sites 110 and the e-retail application 103, and/or some of which are sold only through the e-retail application 103. Each flow center 114 can house all of the products sold through the e-retail application 103 or can house a portion of the products sold through the e-retail application 103. In general, each of the flow centers 114 houses more products than are offered via one of the retail sites 110.

According to the architecture 100 of FIG. 1, each of the flow centers 114 is associated with one or more retail sites 110. Standing hauling routes 118, which have known timing patterns and known costs of hauling, exist between each flow center 114 and one or more respective retail sites 110. For example, a standing hauling route may correspond to a daily route performed by a truck having a predetermined capacity. The standing hauling routes 118 operate to replenish existing product offerings and/or deliver new product offerings for sale at a specific retail site 110. The actual hauling can be performed by truck, train or other type of inventory transfer vehicle. Standing hauling routes 118 can also exist between a plurality of flow centers 114 as well as between a plurality of retail sites 110.

In certain embodiments, the architecture 100 further includes one or more distribution sites 120 as additional fulfillment nodes 109. In typical operation, the distribution sites 120 are at the top of a product flow stream wherein pallets of products delivered at a distribution site are distributed downstream to flow centers 114 and further downstream to retail sites 110 (a distribution site 120 may distribute product directly downstream to a retail site 110). However, the distribution sites 120 can also serve as intermediary product inventory housing sites and/or transfer sites between a flow center 114 and a retail site 110, between flow centers 114, and/or between retail sites 110.

Generally, products received on pallets at distribution sites are de-palletized and delivered on an individual basis to flow centers 114 and retail sites 110, to avoid storage of palletized products at either location. This allows for decreased storage space at flow centers 114 and retail sites 110 when coupled with accurate prediction of item demand at stores.

In certain examples, when considering the above-described architecture 100, it is desirable to utilize retail sites 110 as the predominant inventory holding locations for the fulfillment of digital customer orders to help reduce shipping expense and to help increase the speed of order delivery. While retail sites 110 are the preferred fulfillment node given their proximity to order delivery addresses, retail sites 110 cannot always fulfill orders for various reasons including ship-from-store eligibility rules, inventory placement and available retail site capacity. Furthermore, the retail site may not typically stock the item that is a subject of a digital customer order. When the inventory to fulfill a digital order is not found at the retail site 110 closest to the delivery address, the next best alternative can be shipping out of another retail site 110 or a nearby flow center 114. In some cases, a digital order must be split among fulfillment nodes 109 (e.g. retail site, flow centers, distribution sites). Making inventory available to the retail site 110 closest to the delivery address from other fulfillment nodes 109 can help to lower expenses, reduce splits and improve order delivery speed. Determining how and which fulfillment nodes 109 to use in moving inventory to the retail site is performed by the order management application 108.

### II. Operation

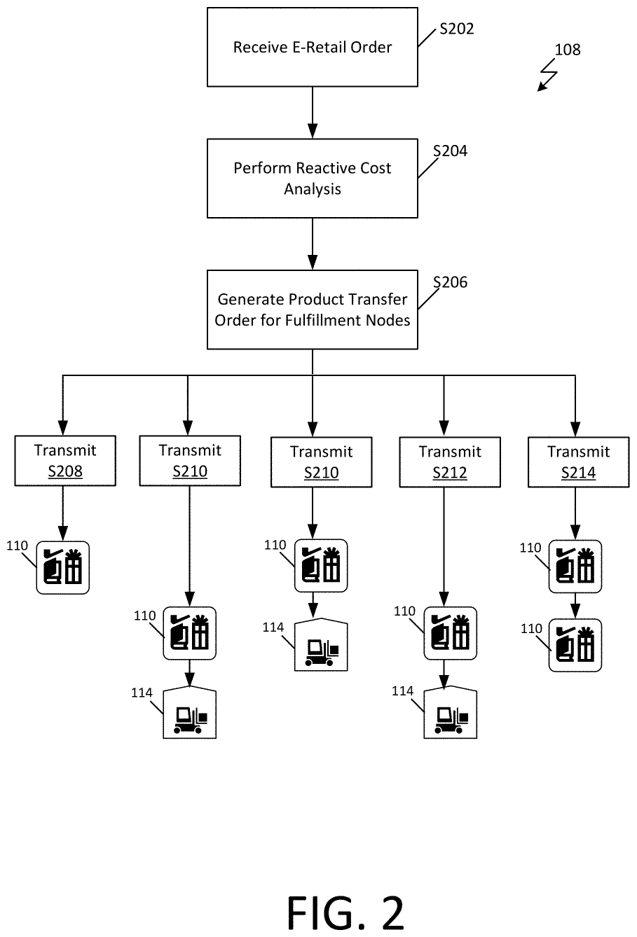

Referring to FIG. 2, a simplified flowchart illustrates the basic operation of the order management application 108 of the present disclosure. As shown, an e-retail order/digital order entered by a customer is received at the order management application, S202. In response, the order management application 108 performs a reactive cost analysis on the digital order to determine the most cost-effective handling option for fulfilling the digital order, S204.

In performing the cost analysis, the order management application 108 assesses the costs involved for one or more handling options based on the selection of a primary retail site and various other known factors such as time and cost of labor, time and cost of hauling, time and cost involved in using a delivery service, location of inventory, operational calendars, operational capacity, lead times, transit times, cut-offs, etc. In certain examples the primary retail is selected to be the retail site that is in closest proximity to the address associated with the order delivery address. In certain examples, the closest proximity retail site is the retail sites that is closest to the delivery address based upon actual distance between the retail site and address. In certain examples, the closes proximity retail site is the retail site that is closest to the address based on delivery zones; delivery zones can vary according to the delivery carrier (e.g. US Postal Service, United Parcel Service, Federal Express, etc).

In certain examples, the cost analysis is performed with the goal of maximizing the number of shippable units for local injection at the selected primary retail site (e.g. the initiation of the final step of order delivery to the customer address from the selected primary retail site). Note that a shippable unit comprises a customer-deliverable package containing one or more of the digitally ordered products. Also, note that in certain embodiments, the cost analysis is performed with the goal of maximizing the number of shippable units for local injection at a primary dedicated pack and ship facility of the retailer; the primary dedicated pack and ship facility of the retailer can be considered in addition to, or alternatively to, the primary retail site.

The cost analysis can be performed in consideration of any number of handling options for the picking/sorting, packing, shipping and delivery of the digitally ordered products. In the example of FIG. 2, the cost analysis considers one or more of: a “local injection” handling option; a “store pack with local injection” handling option; a “ship injection” handling option; a “merge in transit from upstream” handling option; and a “merge in transit local” handling option. Each of the noted handling options are described in further detail below.

Once the most cost-effecting handling option has been determined, the order management application 108 generates a product transfer order, S206. The product transfer order is transmitted to the computing devices located at the various fulfillment nodes 109 (e.g., retail site(s), flow center site(s), distribution site(s)) identified in the determined handling option; the product transfer order puts into motion the acts, processes and/or operations, performed by individuals or machine, necessary to transfer product and fulfill the digital order.

In the example of FIG. 2, the product transfer order can be transmitted to the primary retail site associated with the “local injection” handling option, S208; to the flow center(s) and primary retail site associated with the “store pack with local injection” handling option, S210; to the flow center(s) and primary retail site associated with the “ship injection” handling option, S212; to the flow center(s) and primary retail site associated with the “merge in transit from upstream” handling option S214; or the primary retail site and non-primary retail site(s) associated with the “merge in transit local” handling option S216. In certain examples, the transfer order can alternatively and/or additionally be transmitted to one or more distribution sites if necessary in fulfillment of a digital order.

### III. Handling Options

### III.A. “Local Injection” Handling Option

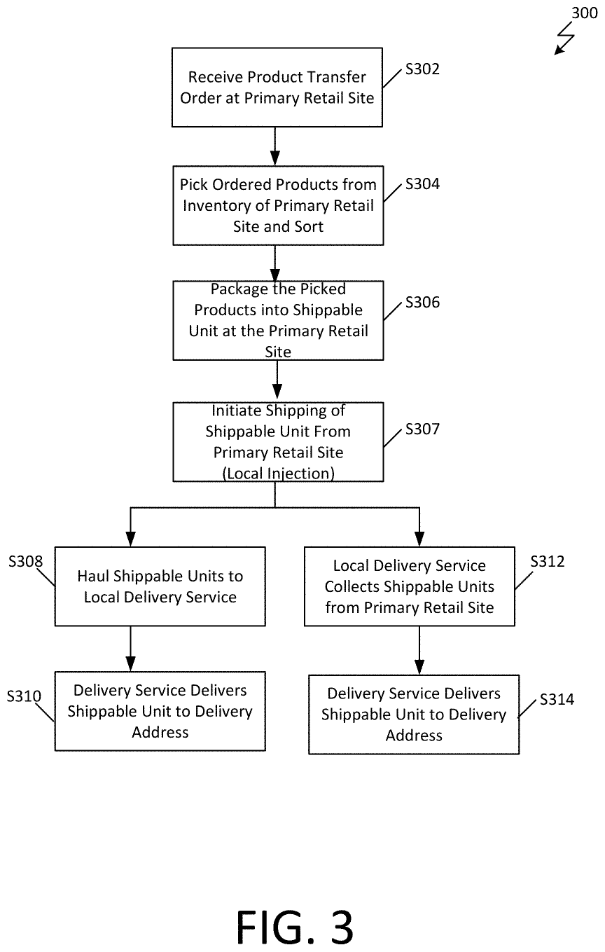

Referring to FIG. 3, a flowchart illustrates the “local injection” handling option process 300. The “local injection” handling option is typically selected under the cost analysis of the order management application 108 when all of the products in a digital order are found within a single primary retail site.

In accordance with the process 300, the transfer order generated by the order management application 108 is received at the primary retail site, S302. In response to receipt of the product transfer order, the products in the digital order are picked from the product inventory of the primary retail site and sorted, S304. The picked products are then packaged into one or more shippable units at the primary retail site, S306, and shipping is initiated from the primary retail site (.e.g., local injection), S307.

The shippable units are then hauled from the primary retail site to a local delivery service (e.g. US Postal Service, United Parcel Service, FedEx, etc., that is in close proximity to the primary retail site and, consequently, in close proximity the retail address), S308, and delivered to the local delivery address, S310. The process 300 results in the “local injection” of digitally ordered products from the primary retail site.

In certain embodiments, the shippable units are collected from the primary retail site by the delivery service, S312, for subsequent delivery, S314. However, the delay in waiting for delivery service collection of the shippable units from the primary retail site can undesirably affect the speed of delivery to the customer.

### III.B. “Store Pack with Local Injection” Handling Option

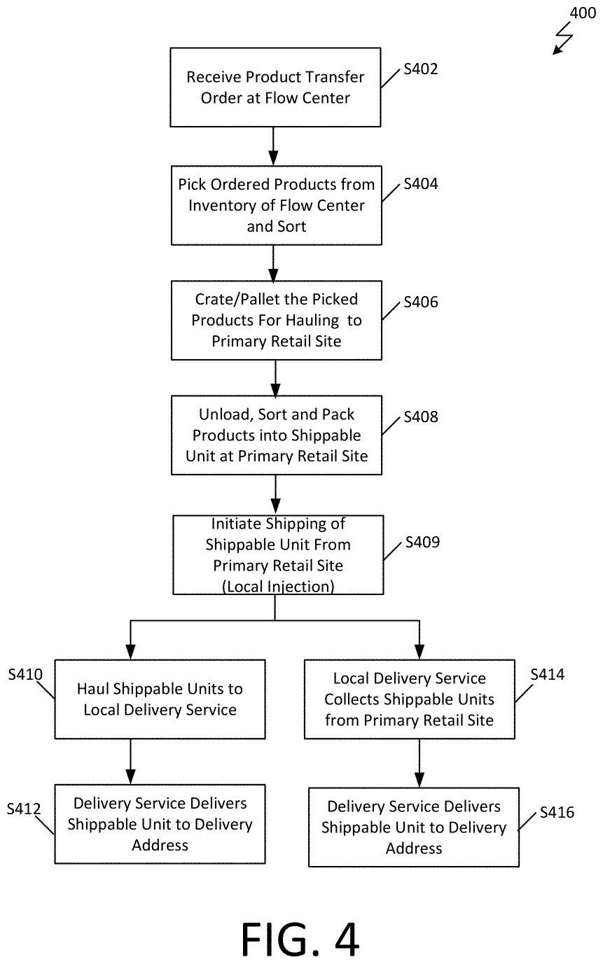

Referring to FIG. 4, a flowchart illustrates the “store pack with local injection” handling option process 400. The “store pack with local injection” handling option is typically selected under the cost analysis of the order management application 108 when all of the products in a digital order are located in flow center that is upstream from the selected primary retail site. In accordance with the process 400, the product transfer order generated by the order management application 108 is received at the upstream flow center, S402. In certain examples, all of the products in a digital order located in a non-primary retail site rather than the flow center.

In response to the product transfer order, the products of the digital order are picked from the product inventory of the flow center, S404, and crated/palleted for hauling in the next available standing hauling route from the flow center to the primary retail site, S406. After receipt of the products of the digital order at the primary retail site, the products are unloaded, sorted and packaged into one or more shippable units, S408, and shipping is initiated from the primary retail site (.e.g., local injection), S409.

The shippable units are then hauled from the primary retail site to a local delivery service, e.g. US Postal Service, United Parcel Service, FedEx, etc., S410, and delivered to the local delivery address, S412. The process 400 results in the “local injection” of digitally ordered products from the primary retail site.

In certain embodiments, the shippable units are collected from the primary retail site by the delivery service, S414, for subsequent delivery, S416. However, the delay in waiting for delivery service collection of the shippable units from the primary retail site can undesirably affect the speed of delivery to the customer.

In certain embodiments, the process 400 can incorporate the use of an intermediary distribution site 120 that is, for example, located upstream from the primary retail site and downstream of the flow center. The distribution site 120 can be utilized to handle the transfer of crated/palleted products of a digital order from a first standing hauling route to a second standing hauling route for ultimate delivery to the primary retail site.

### III.C. “Ship Injection” Handling Option

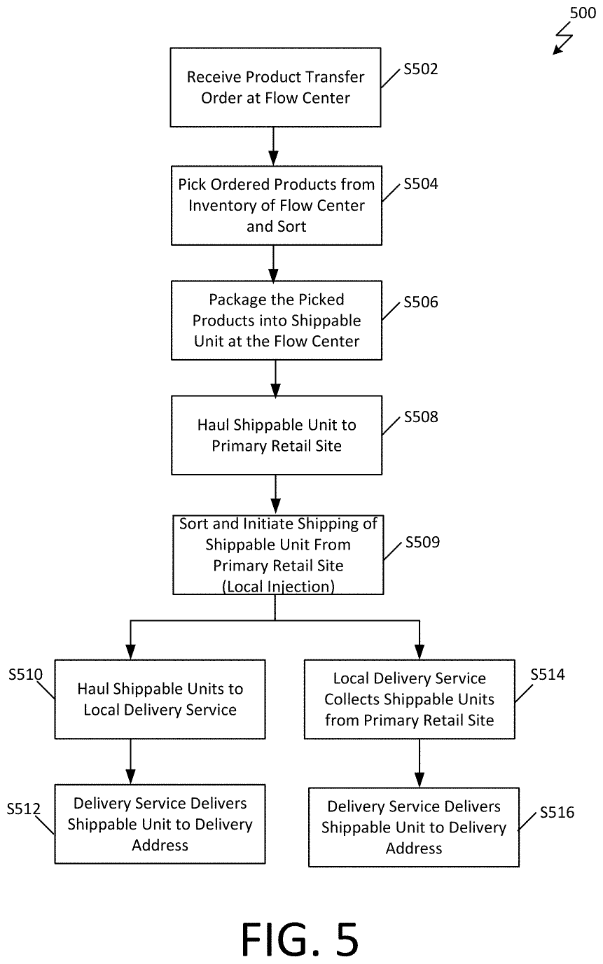

Referring to FIG. 5, a flowchart illustrates the “ship injection” handling option process 500. The “ship injection” handling option is typically selected under the cost analysis of the order management application 108 when all of the products in a digital order are located in a flow center that is upstream from the selected primary retail site and when the “ship injection” handling option is deemed to be more cost effective than the “store pack with local injection” handling option. In certain examples, all of the products in a digital order can be located in a non-primary retail site rather than the flow center.

In accordance with the process 500, a product transfer order generated by the order management application 108 is received at the upstream flow center, S502. Details regarding generation of a product transfer order are provided in copending U.S. Provisional Patent application No. 62/632,095, the disclosure of which is hereby incorporated by reference in its entirety. In response to the transfer order, the products of the digital order are picked from the inventory of the flow center and sorted, S504. The picked products are then packaged into one or more shippable units at the flow center, S506. The shippable units are crated/palleted for hauling in the next available standing hauling route from the flow center to the primary retail site, S508.

After receipt of the shippable units at the retail site, the shippable units are subsequently sorted and shipping is initiated from the primary retail site (e.g., local injection), S509. The shippable units are hauled from the primary retail site to a local delivery service, e.g. US Postal Service, United Parcel Service, FedEx, etc., S510, and delivered to the local delivery address, S512. The process 500 results in the “local injection” of digitally order products from the primary retail site.

In certain embodiments, the shippable units are collected from the primary retail site by the delivery service, S514, for subsequent delivery, S516. However, the delay in waiting for delivery service collection of the shippable units from the primary retail site can undesirably affect the speed of delivery to the customer.

In certain embodiments, the process 500 can alternatively and/or additionally incorporate the use of distribution site(s) 120 as necessary for order fulfillment.

### III.D. “Merge in Transit from Upstream” Handling Option

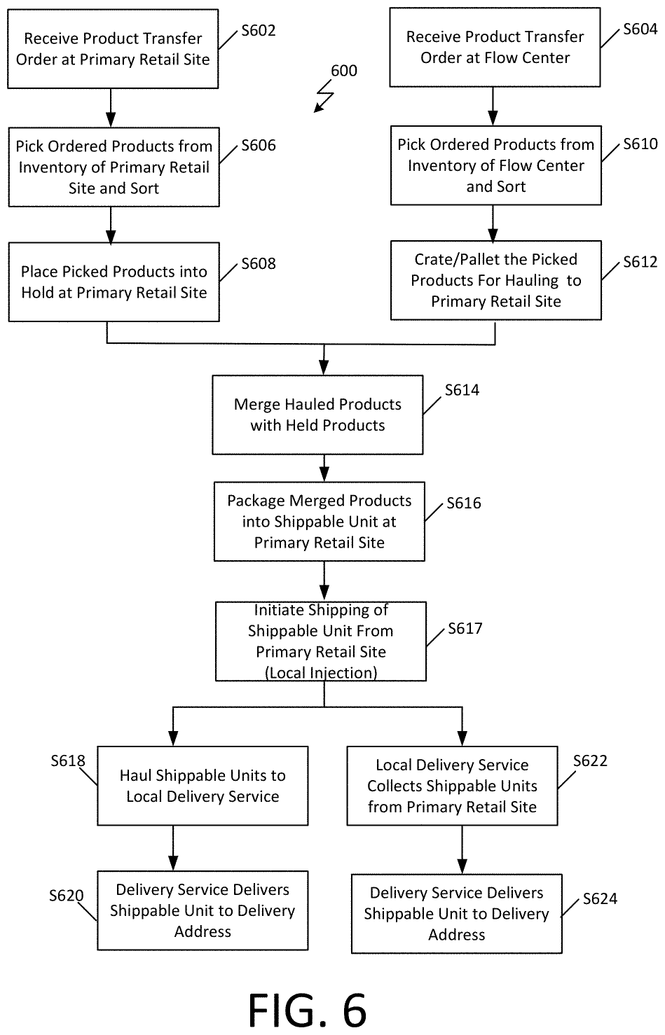

Referring to FIG. 6, a flowchart illustrates the “merge in transit from upstream” handling option process 600. The “merge in transit from upstream” handling option is typically selected under the cost analysis of the order management application 108 when a portion of the product inventory needed to fulfill a digital order is located at a primary retail site and when the remaining portion of the product inventory needed to fulfill the digital order is located at a flow center upstream from the primary retail site.

In accordance with the process 600, the product transfer order generated by the order management application 108 is received at both the primary retail site, S602, and the upstream flow center, S604. The product transfer order can be delivered to both locations at the same or different times. In response to the product transfer order received at the primary retail site, the portion of products available from the primary retail site are picked from the product inventory of the primary retail site and sorted, S606. The picked products are then placed in hold at the primary retail site, S608.

In response to the product transfer order received at the flow center, the remaining portion of products available from flow center are picked from the product inventory of the flow center and sorted, S610, and are crated/palleted for hauling on the next available standing hauling route from the flow center to the primary retail site, S612. Upon receipt of the crated/palleted products by the primary retail site, the flow center products are merged with the held products, S614. The merged products are than packaged at the primary retail site into one or more shippable units, S616, and shipping is initiated from the primary retail site (.e.g., local injection), S617.

The shippable units are subsequently hauled from the primary retail site to a local delivery service, e.g. US Postal Service, United Parcel Service, FedEx, etc., S618, and delivered to the local delivery address, S620. The process 600 results in the “local injection” of digitally order products from the retail site.

In certain embodiments, the shippable units are collected from the retail site by the delivery service, S622, for subsequent delivery, S624. However, the delay in waiting for delivery service collection of the shippable units from the primary retail site can undesirably affect the speed of delivery to the customer.

In certain embodiments, the process 600 can alternatively and/or additionally incorporate the use of distribution site(s) 120 as necessary for order fulfillment.

### III.E. “Merge in Transit Local” Handling Option

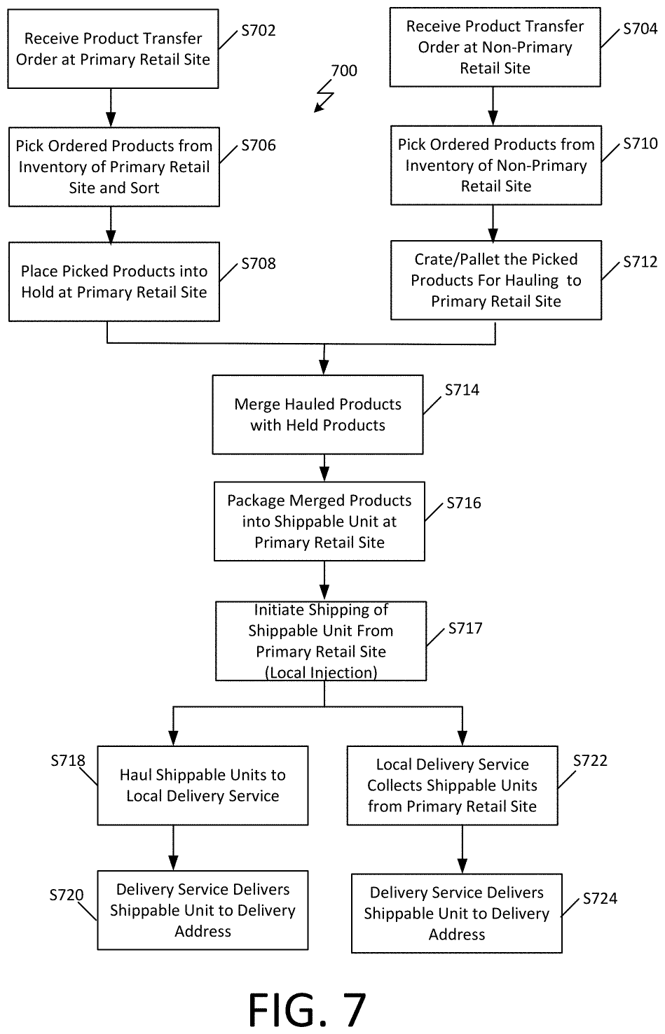

Referring to FIG. 7, a flowchart illustrates the “merge in transit local” handling option process 700. The “merge in transit local” handling option is typically selected under the cost analysis of the order management application 108 when the product inventory needed to fulfill a digital order is partially located at a primary retail site and when the remaining product inventory needed to fulfill the digital order is located at a different, non-primary retail site (or a plurality of non-primary retail sites) that is upstream and/or within a close proximity (e.g. a predetermined distance) to the primary retail site.

In accordance with the process 700, the product transfer order generated by the order management application 108 is received at the primary retail site, S702, and at the non-primary retail site(s) that have been selected to fulfill the digital order, S704. The product transfer order can be delivered to the primary retail site and the non-primary retail site(s) at the same time or at different times. In response to receipt of the product transfer order, the products located at the primary retail site are picked from the primary retail site product inventory and sorted, S706. The picked products are then placed in hold at the primary retail site, S708.

Further, in response to receipt of the product transfer order, the products located at the non-primary retail site(s) are picked from their respective retail site inventory and sorted, S710. The picked items are then crated/palleted for hauling on the next available standing hauling route from the non-primary retail site to the primary retail site, S712.

Upon receipt of the crated/palleted products by the primary retail site, the non-primary retail site products are merged with the held products, S714. The merged products are than packaged at the primary retail site into one or more shippable units, S716 and shipping is initiated from the primary retail site (.e.g., local injection), S717.

The shippable units are subsequently hauled from the primary retail site to a local delivery service, e.g. US Postal Service, United Parcel Service, FedEx, etc., S718, and delivered to the local delivery address, S720. The process 700 results in the “local injection” of digitally order products from the primary retail site.

In certain embodiments, the shippable units are collected from the primary retail site by the delivery service, S720, for subsequent delivery, S722. However, the delay in waiting for delivery service collection of the shippable units from the primary retail site can undesirably affect the speed of delivery to the customer.

In certain embodiments, the process 700 can alternatively and/or additionally incorporate the use of distribution site(s) as necessary for order fulfillment.

### IV. Cost Analysis

As noted earlier, the cost analysis is generally performed with the goal of maximizing the number of shippable units for local injection at the selected primary retail site. Numerous factors can be considered and can affect the result of the cost analysis. An example of cost analysis includes consideration of costs associated with a preliminary fulfillment stage of a digital order and consideration of costs associated with final fulfillment stage of a digital order; each of these costs can generally be grouped into labor costs, materials and equipment costs, and transportation costs based on ordered item location.

The preliminary fulfillment stage includes the procedures/processes that take place to produce a shippable unit and position it at a flow center or retail site for the final fulfillment stage of delivery to the address associated with the digital order. The costs for the preliminary fulfillment stage can include one or more of the costs found in Table 1.

TABLE 1

A. Costs associated with picking an ordered item
from the inventory of an upstream flow center.
B. Costs associated with sorting the picked item
at the upstream flow center.
C. Costs associated with packing the sorted item
at the upstream flow center.
D. Costs associated with loading the packed item
onto a line hauler at the upstream flow center.
E. Costs associated with hauling the loaded item
to a downstream retail site.
F. Costs associated with unloading the packed item
from the line hauler at the retail site.
G. Costs associated with picking an ordered item
from the inventory of the retail site.
H. Costs associated with packing the ordered item
at the retail site.
I. Costs associated with merging the items
from the flow center with the items from the retail site
K. Costs associated with packing the merged items
at the retail site.

The final fulfillment stage includes the procedures/processes that take place to transport a shippable unit from the retail site to the delivery to the address associated with the digital order. The costs for the final fulfillment stage can include one or more of the costs found in Table 2.

TABLE 2
A. Costs associated with sorting a packaged/shippable unit at the
retail site.
B. Costs associated with hauling the sorted packaged/shippable unit to a
delivery service location.
C. Costs associated with delivery of the packaged/shippable unit by the
delivery service.

In certain examples, the costs are determined on a per ordered item basis for each possible handling option and compared against one another to determine the most cost-effective handling option to deliver digitally ordered items to the order address. The cost analysis inherently takes into consideration the availability of the ordered products at the locations in closest proximity to the delivery address. For example, if an ordered product is not available at the primary retail site, extra cost may be incurred in fulfilling the order by having to obtain the ordered product from a retail site or flow center that is located at a further distance from the order address.

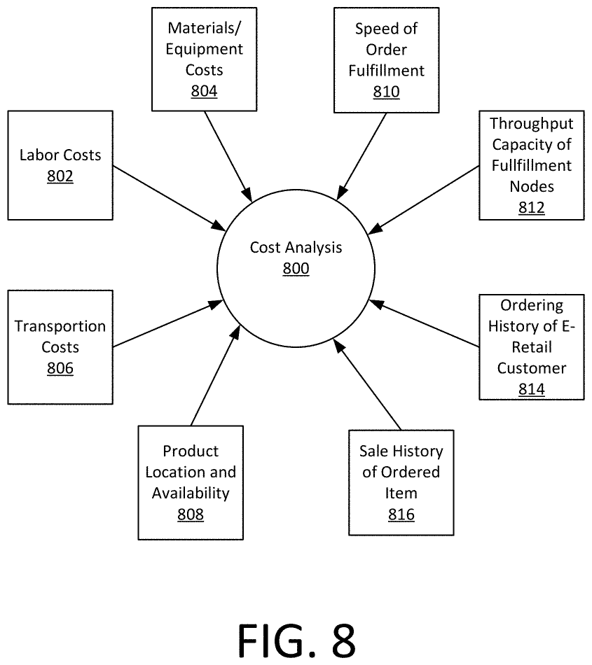

FIG. 8 illustrates an example of a cost analysis 800 that goes beyond considering labor costs 802, materials and equipment costs 804, and transportation costs 806 in view of product location and availability 808. The cost analysis 800 considers one or more additional factors such as speed of order fulfillment 810, throughput capacity of the order fulfillment nodes 812, ordering history of the e-retail customer 814, and sale history of an ordered item 816.

As noted above, in certain examples, the cost analysis 800 also considers the speed of order fulfillment 810. For example, a comparison of handling options finds a first handling option to be cheaper than a second handling option yet the second handling option will fulfill the order more quickly than the first. In such a situation, the cost analysis can choose the more expensive second handling option, as long as the cost of the second handling option is within a pre-defined acceptable cost window, with the benefit of a happy customer that receives their order in a shorter amount of time.

In certain examples, the cost analysis 800 also considers the throughput capacity of the various fulfillment nodes 812 needed to handle a new digital order. For example, a comparison of handling options finds a first handling option to be cheaper than a second handling option however the fulfillment node(s) involved with the first handling option are already operating a 90% throughput capacity while the fulfillment node(s) involved with second handling option are operating at a 50% throughput capacity. In such a situation, the cost analysis can choose the more expensive handling option, as long as the cost of the second handling option is within a pre-defined acceptable cost window, with the benefit that the fulfillment node(s) involved with the first handling option are not overly taxed and the possible benefit the that second handling option may result in quicker fulfillment of the order due to the ability of the fulfillment node(s) to deal with the extra capacity in the form of the digital order.

In certain examples, the cost analysis 800 also considers the ordering history of the customer 814 that has placed the digital order. For example, a comparison of handling options finds a first handling option to be cheaper than a second handling option however the ordering history of the customer shows that they have placed a predetermined requisite number of orders or have spent a predetermined requisite amount of money. In such a situation, the cost analysis can choose the more expensive second handling option, as long as the cost of the second handling option is within a pre-defined acceptable cost window, that can provide faster order fulfillment of a valuable customer.

In certain examples, the cost analysis also considers the sale history of an item 816 needed to fulfill a digital order. For example, a comparison of handling options finds a first handling option to be cheaper than a second handling option in fulfilling a digital order. However, the first handling option requires that one of the ordered items be pulled from the retail site inventory in fulfillment of the order. The sale history of the item at the retail site shows the item to be a frequently purchased item (e.g. the number of purchases of the item meet a pre-defined threshold number of items sold). In such a situation, the cost analysis can choose the more expensive second handling option, as long as the cost of the second handling option is within a pre-defined acceptable cost window, enabling the item to remain available for sale at the retail site.

A greater or lesser number of factors as well as different factors, as appropriate to the application, can be included in the cost analysis.

### V. Computing Device

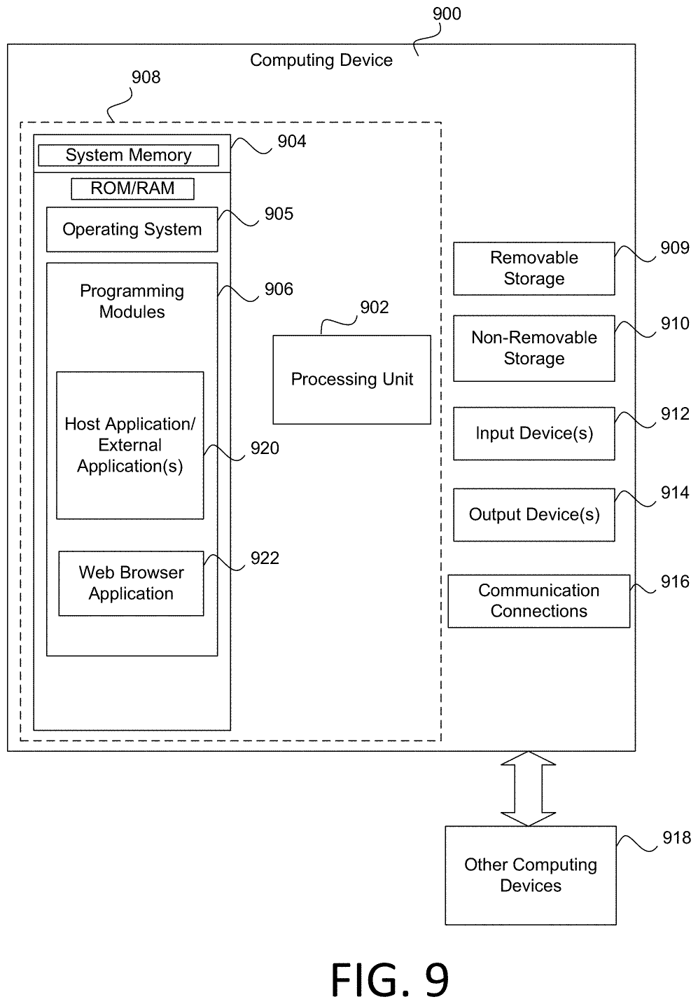

Referring FIG. 9, the embodiments and functionalities described herein may operate via a multitude of computing systems such as the computing devices 102, 106, 112, 116 above with reference to FIG. 1, including wired and wireless computing systems, mobile computing systems (e.g., mobile telephones, tablet or slate type computers, laptop computers, etc.). In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. FIG. 9 and the associated description provides a discussion of a variety of operating environments in which embodiments of the invention may be practiced. However, the devices and systems illustrated and discussed with respect to FIG. 9 are for purposes of example and illustration, and are not limiting of a vast number of computing device configurations that may be utilized for practicing embodiments of the invention, described herein.

FIG. 9 is a block diagram illustrating example physical components of a computing device 900 with which embodiments of the invention may be practiced. The computing device components described below may be suitable for the computing devices described above, for example, the computing devices 102, 106, 112, 116. In a basic configuration, computing device 900 may include at least one processing unit 902 and a system memory 904. Depending on the configuration and type of computing device, system memory 904 may comprise, but is not limited to, volatile (e.g. random access memory (RAM)), non-volatile (e.g. read-only memory (ROM)), flash memory, or any combination. System memory 904 may include operating system 905 and one or more programming modules 906, which are suitable for running applications such as external application(s) 920 and a web browser 922 or server applications. Operating system 905, for example, may be suitable for controlling the operation of computing device 900. Furthermore, embodiments of the invention may be practiced in conjunction with a graphics library, other operating systems, or any other application program and is not limited to any particular application or system. This basic configuration is illustrated in FIG. 9 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910.

As stated above, a number of program modules and data files may be stored in system memory 904, including operating system 905. In addition, other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality of server applications or client applications may be implemented via application-specific logic integrated with other components of the computing device 900 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 904, removable storage 909, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Although the description of computer readable storage media contained herein refers to a mass storage device, such as a hard disk or solid state disk, it should be appreciated by those skilled in the art that computer-readable data storage media can include any available tangible, physical device or article of manufacture from which the processing unit 902 can read data and/or instructions. In certain embodiments, the computer-readable storage media comprises entirely non-transitory media.

Computing device 900 may also have input device(s) 912 such as a keyboard, a mouse, a pen, a sound input device, a touch input device, etc. Output device(s) 914 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. Computing device 900 may include communication connections 916 allowing communications with other computing devices 918. Examples of suitable communication connections 916 include, but are not limited to, RF transmitter, receiver, and/or transceiver circuitry; universal serial bus (USB), parallel, or serial ports, and other connections appropriate for use with the applicable computer readable media.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. In various embodiments, the types of networks used for communication between the computing devices that make up the present invention include, but are not limited to, an internet, an intranet, wide area networks (WAN), local area networks (LAN), and virtual private networks (VPN).

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A method comprising:
receiving an e-retail order comprising one or more products sold through an e-retail application that is associated with an established infrastructure of a plurality of retail sites and a plurality of flow centers;
determining a location of a primary retail site from among the plurality of retail sites, wherein the primary retail site comprises the retail site in closest proximity to a delivery address associated with the e-retail order;
determining a location of the ordered products from among the inventory of the primary retail site and the inventory of a flow center associated with the primary retail site;
determining the most cost-effective handling option to obtain the ordered products from the inventories of the primary retail site and/or the associated flow center, wherein the determination of the most cost-effective handling option is based on initiating delivery of a shippable unit containing the ordered products from the primary retail site;
executing the determined most-cost effective handling option, wherein the result of the execution is the shippable unit being located at the primary retail site; and
initiating delivery of the shippable unit to the delivery address from the primary retail site.

2. The method of claim 1, wherein the associated flow center is upstream from the primary retail site.

3. The method of claim 2, wherein an established hauling route exists between the primary retail site the upstream flow center.

4. The method of claim 3, wherein at least one product of the e-retail order is determined to be located at the flow center and at least another product of the e-retail order is determined to be located at the primary retail site.

5. The method of claim 4, further comprising hauling that at least one product at the flow center over the established hauling route to the primary retail site, merging the hauled product with the product located at the primary retail site, and packaging the merged products into the shippable unit at the retail site.

6. The method of claim 1, wherein all products of the e-retail order are located at the flow center, and wherein the method further comprises hauling all products of the e-retail order from the flow center to the primary retail site, and packaging all products into the shippable unit at the retail site.

7. The method of claim 1, wherein all products of the e-retail order are located at the flow center, and wherein the method further comprises packaging all products of the e-retail order into the shippable unit at the flow center, and hauling to the shippable unit from the flow center to the primary retail site.

8. The method of claim 1, wherein the handling options considered when determining the most cost-effective handling option include one or more of: a “local injection” handling option; a “store pack with local injection” handling option; a “ship injection” handling option; a “merge in transit from upstream” handling option; and a “merge in transit local” handling option.

9. The method of claim 1, wherein initiating delivery of the shippable unit to the delivery address from the primary retail site includes hauling the shippable unit from the primary retail site to a delivery service.

10. A system comprising:
a memory device storing instructions; and
a processor configured to read and execute the instructions stored in the memory device, wherein execution of the instructions causes the processor to:
receive an e-retail order comprising one or more products sold through an e-retail application that is associated with an established infrastructure of a plurality of retail sites and a plurality of flow centers;
determine a location of a primary retail site from among the plurality of retail sites, wherein the primary retail site comprises the retail site in closest proximity to a delivery address associated with the e-retail order;
determine a location of the ordered products from among the inventory of the primary retail site and the inventory of a flow center associated with the primary retail site;
determine the most cost-effective handling option to obtain the ordered products from the inventories of the primary retail site and/or the associated flow center, wherein the determination of the most cost-effective handling option is based on initiating delivery of a shippable unit containing the ordered products from the primary retail site; and
issue a product transfer order to the primary retail site and/or the associated flow center having the ordered products in inventory, wherein the product transfer order dictates whether packaging of the ordered products into the shippable unit occurs at the associated flow center or the primary retail site.

11. The system of claim 10, wherein at least one of the ordered products is located at the associated flow center and wherein the product transfer order identifies a primary retail site to which any of the ordered products located at the associated flow center are hauled.

12. The system of claim 10, wherein the determination of the most cost-effective handling option considers known costs of established hauling routes between the associated flow center and the primary retail site.

13. The system of claim 10, wherein determination of the most cost-effective handling option considers known costs of labor associated with picking, packaging and/or hauling the ordered products.

14. The system of claim 10, wherein the determination of the most cost-effective handling option includes considering one or more handling options selected from: a “local injection” handling option; a “store pack with local injection” handling option; a “ship injection” handling option; a “merge in transit from upstream” handling option; and a “merge in transit local” handling option.

15. A method comprising:
receiving an e-retail order comprising one or more products sold through an e-retail application that is associated with an established infrastructure of a plurality of retail sites and a plurality of flow centers;
determining a location of a primary retail site from among the plurality of retail sites, wherein the primary retail site comprises the retail site in closest proximity to a delivery address associated with the e-retail order;
determining a location of the ordered products from among the inventory of the primary retail site, the inventory of a flow center associated with the primary retail site, and the inventory of non-primary retail sites within a predetermined distance from the primary retail site;
determining the most cost-effective handling option to obtain the ordered products from the inventories of the primary retail site, the associated flow center, and/or the non-primary retail sites wherein the determination of the most cost-effective handling option is based on initiating delivery of a shippable unit containing the order products from the primary retail site;
issuing a product transfer order to initiate execution of the determined most-cost effective handling option, wherein the result of the execution is the shippable unit being located at the primary retail site; and
initiating delivery of the shippable unit to the delivery address from the primary retail site.

16. The method of claim 15, wherein an established hauling route exists between the primary retail site the associated flow center and wherein an established hauling route exists between the primary retail site and the non-primary retail sites within a predetermined distance.

17. The method of claim 15, wherein all products of the e-retail order are located at the flow center or all products of the e-retail order are located at one of the non-primary retail sites, and wherein the method further comprises hauling all products of the e-retail order from either the flow center or the one of the non-primary retail sites to the primary retail site, and packaging all products into the shippable unit at the retail site.

18. The method of claim 15, wherein all products of the e-retail order are located at the flow center or all products of the e-retail order are located at one of the non-primary retail sites, and wherein the method further comprises packaging all products of the e-retail order into the shippable unit at the flow center or non-primary retail site, respectively, and hauling to the shippable unit from the flow center or the non-primary retail site, respectively, to the primary retail site.

19. The method of claim 15, wherein the handling options considered when determining the most cost-effective handling option include one or more of: a “local injection” handling option; a “store pack with local injection” handling option; a “ship injection” handling option; a “merge in transit from upstream” handling option; and a “merge in transit local” handling option.

20. The method of claim 15, wherein initiating delivery of the shippable unit to the delivery address from the primary retail site includes hauling the shippable unit from the primary retail site to a delivery service.
